(19) United States
(12) Patent Application Publication
(10) Pub. No.: US 2013/0316732 A1
(43) Pub. Date: Nov. 28, 2013

(54) METHOD AND SYSTEM FOR MANAGING DEVICES

(71) Applicant: Alert GPS Holdings, Corp., South Jordan, UT (US)

(72) Inventors: Russell Scott Thornton, West Jordan, UT (US); Brandon David Wright, Salt Lake City, UT (US)

(73) Assignee: Alert GPS Holdings, Corp., South Jordan, UT (US)

(21) Appl. No.: 13/901,731

(22) Filed: May 24, 2013

Related U.S. Application Data
(60) Provisional application No. 61/651,944, filed on May 25, 2012.

(51) Int. Cl. H04W 4/02

(52) U.S. Cl. CPC H04W 4/02
USPC 455/456.1

(57) ABSTRACT

Systems and methods for managing devices, such as computing devices, are disclosed. In an aspect, one method comprises determining one or more available communication networks, determining a first position in association with the one or more available communication networks, if a change is detected in the one or more available communication networks, or if the first position is not of sufficient quality, determining a second position, and if no change in the one or more available communication networks is detected, and the first position is of sufficient quality, retrieving the first position.

### CROSS REFERENCE TO RELATED PATENT APPLICATION

This application claims priority to U.S. Patent Application No. 61/651,944 filed May 25, 2012, herein incorporated by reference in its entirety.

### BACKGROUND

Currently, global position systems (GPS) based solutions require line of sight to acquire an accurate GPS location. When no line of sight is available, GPS-based devices typically return the last known location and/or rely on alternative location data such as assisted global positioning system (AGPS) data. When less than optimal line of sight is available, current solutions can experience significant GPS “bounce”, which can be characterized by the device reporting locations that typically vary by between about 100 feet and about 1500 feet from the actual location of the device. Due to shortcomings inherent in the technology, GPS bounce can also occur when a device has clear line of sight with GPS satellites.

There is a strong relationship between the difficulty a device has in acquiring a quality GPS location and the amount of power consumed by the device. Current system, methods, and device do not provide a sufficient means to maximize positioning accuracy, while minimizing power consumption.

### SUMMARY

It is to be understood that both the following general description and the following detailed description are exemplary and explanatory only and are not restrictive. Provided are methods and systems for managing devices. As an example, the systems and methods can be used to provide position information, while minimizing power consumption.

In an aspect, Android OS, iOS and other operating systems or devices (e.g., Wi-Fi enabled mobile devices) can search for and view known and unknown available networks (e.g., Wi-Fi) networks. These networks allow a user or system to select and establish a connection for data transmission and other purposes. For example, Wi-Fi networks typically have an available radius of +/−200 feet. In an aspect, smartphone-based location based services (LBS) solutions typically use a combination of GPS, Network data, and Wi-Fi in producing locations. Known Wi-Fi networks with a known and/or registered IP address can be checked against a directory (e.g., such as provided by Google or Skyhook) to obtain location information. Network data can be checked against known cell phone towers and receivers. Wi-Fi and Network data can be used to maximize accuracy when GPS line of sight is unavailable, which can be more useful in large metropolitan areas.

In an aspect, the systems and methods of the present disclosure can be applied to maximize accuracy and optimize battery life on a device, such as a mobile device, smartphone, computing device, and the like.

In an aspect, one method for optimizing battery and other performance metrics comprises determining an array comprising one or more available communication networks and determining a first position (e.g., via GPS, AGPS, GLONASS, Galileo, geographic IP lookup, known location of one or more of the networks in the array and/or other means). In an aspect, the array need not be obtained prior to the position. As an example a first position (or an “effective” first position based on the averaging a plurality of positions, weighted or not according to context) can be determined from a set of positions obtained by utilizing one or more technologies. As an example, in addition to utilizing that position as the “current position”, the position can be associated with the network array. As a further example, the position can be obtained first and then associated with the array, with the position still being associated with the array. If a change is detected in the array (e.g., upon the expiration of a prescribed interval, or otherwise), a second position can be determined (or “effective” second position based on the averaging of a set of positions obtained from one or more of the preceding partially enumerated technologies). If no change in the array is detected (e.g., after a prescribed interval), the first position (or “effective” first position) can be utilized as the “current position.”

In another aspect, a method comprises determining (e.g., identifying detecting a broadcast signal, etc.) one or more available communication networks; determining a first position in association with and/or based on the one or more available communication networks (or information from the one or more available networks); if a change is detected in the one or more available communication networks, determining a second position; and if no change in the one or more available communication networks is detected, retrieving the first position.

In another aspect, a method comprises determining (e.g., identifying detecting a broadcast signal, etc.) one or more available communication networks; determining a first position in association with and/or based on the one or more available communication networks (or information from the one or more available networks); determining a quality of the first position; if the quality of the first position is insufficient, determining a second position; and if the quality of the first position is sufficient, retrieving the first position. As an example, a quality of a first position can be defined by a pre-defined threshold of accuracy, by comparison to other calculated or known values or reference, and/or by other metrics used to define accuracy of location. As a further example, the sufficiency of a position (e.g., the first position) can be defined by a pre-determined threshold, by comparison to other calculated or known values or reference, and/or by other metrics used to define acceptable value of position.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an exemplary computing device;

FIG. 2 is an exemplary system;

FIG. 3A is an exemplary method;

FIG. 3B is an exemplary method;

FIG. 4 is an exemplary method;

FIG. 5 is an exemplary method;

FIG. 6 is an exemplary method; and

FIG. 7 is an exemplary method.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

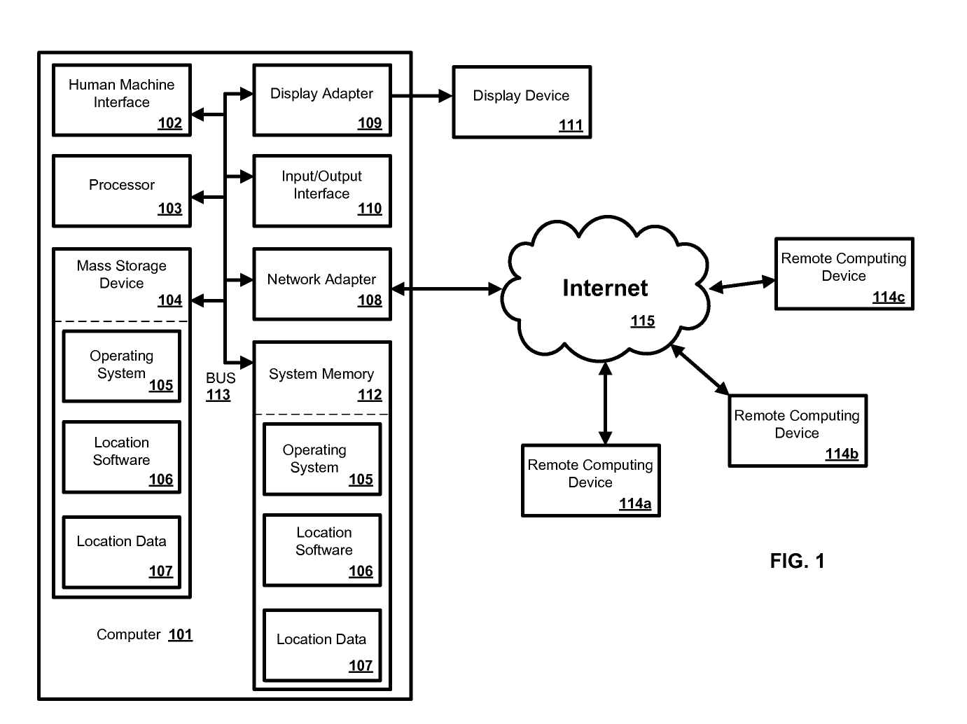

FIG. 1 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, location software 106, location data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as location data 107 and/or program modules such as operating system 105 and location software 106 that are immediately accessible to and/or are presently operated on by the processing unit 103.

In another aspect, the computer 101 can also comprise other removable/non-removable, volatile/non-volatile computer storage media. By way of example, FIG. 1 illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and location software 106. Each of the operating system 105 and location software 106 (or some combination thereof) can comprise elements of the programming and the location software 106. Location data 107 can also be stored on the mass storage device 104. Location data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 101 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. It is contemplated that the computer 101 can have more than one display adapter 109 and the computer 101 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to the computer 101 via Input/Output Interface 110. Any step and/or result of the methods can be output in any form to an output device. Such output can be any form of visual representation, including, but not limited to, textual, graphical, animation, audio, tactile, and the like.

The computer 101 can operate in a networked environment using logical connections to one or more remote computing devices 114a,b,c. By way of example, a remote computing device can be a personal computer, portable computer, a server, a router, a network computer, a peer device or other common network node, and so on. Logical connections between the computer 101 and a remote computing device 114a,b,c can be made via a local area network (LAN) and a general wide area network (WAN). Such network connections can be through a network adapter 108. A network adapter 108 can be implemented in both wired and wireless environments. Such networking environments are conventional and commonplace in offices, enterprise-wide computer networks, intranets, and the Internet 115.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of location software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

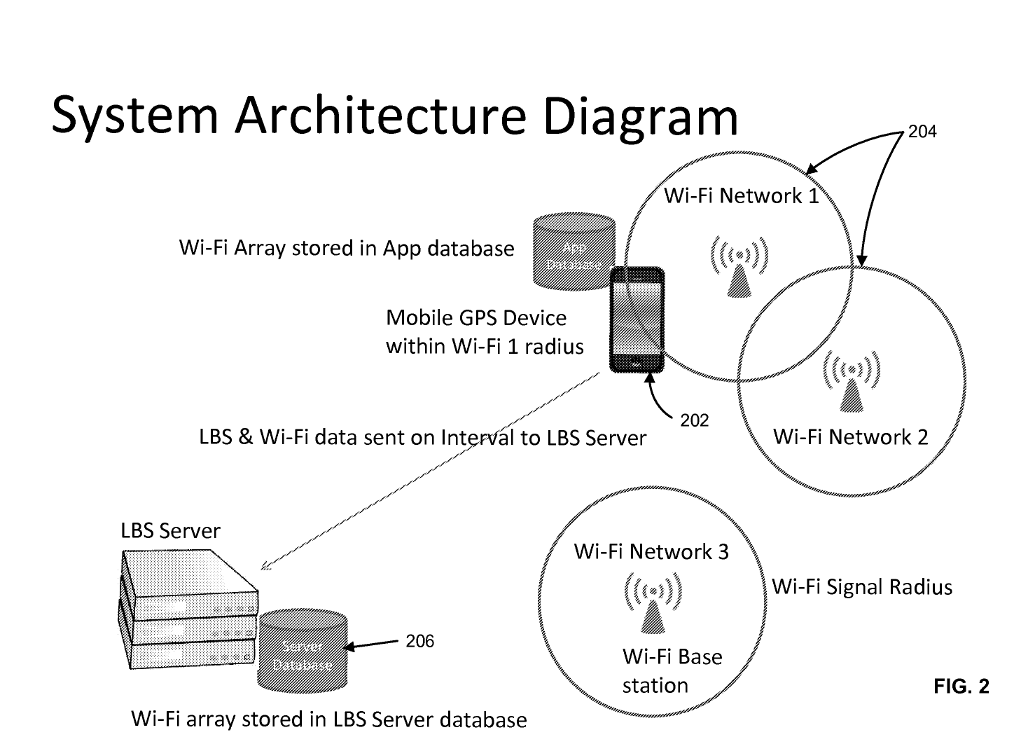

FIG. 2 illustrates an exemplary system. In an aspect, the system can comprise a mobile device 202 (e.g., GPS device, smartphone, computing device, etc.) configured to execute an LBS application or receive LBS information. As an example, the mobile device can detect or receive information relating to one or more available networks 204 (e.g., communication network, WiFi network, wireless network, etc.) that are within a pre-determined range. In an aspect, LBS data and Wi-Fi network data can be stored on the mobile device or other database and transmitted to an LBS server database 206.

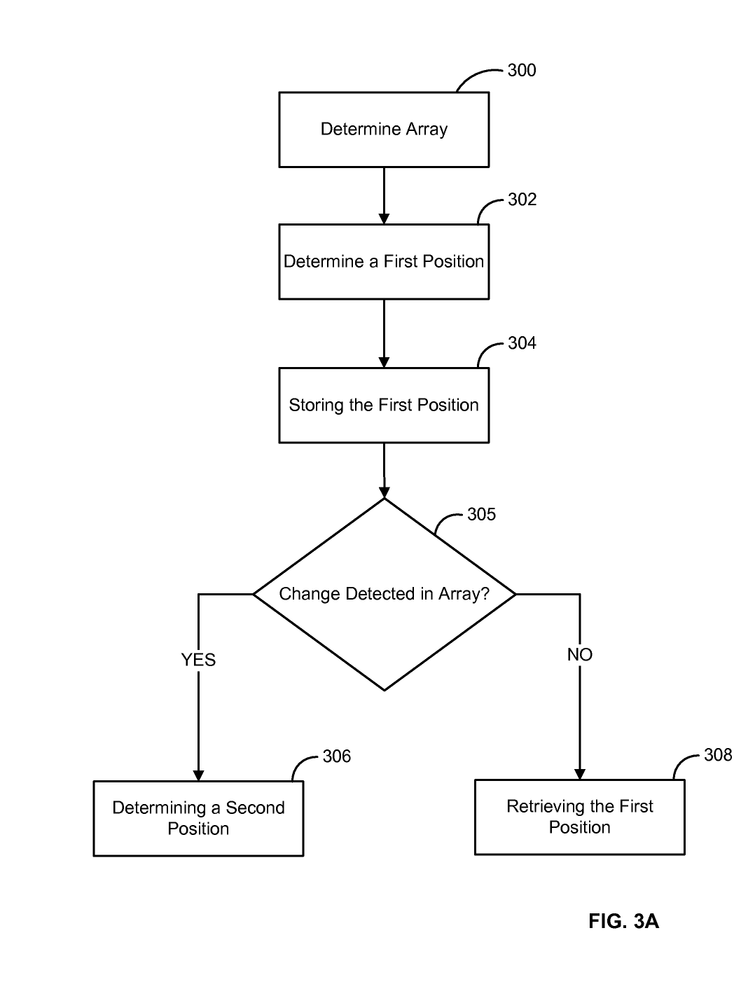

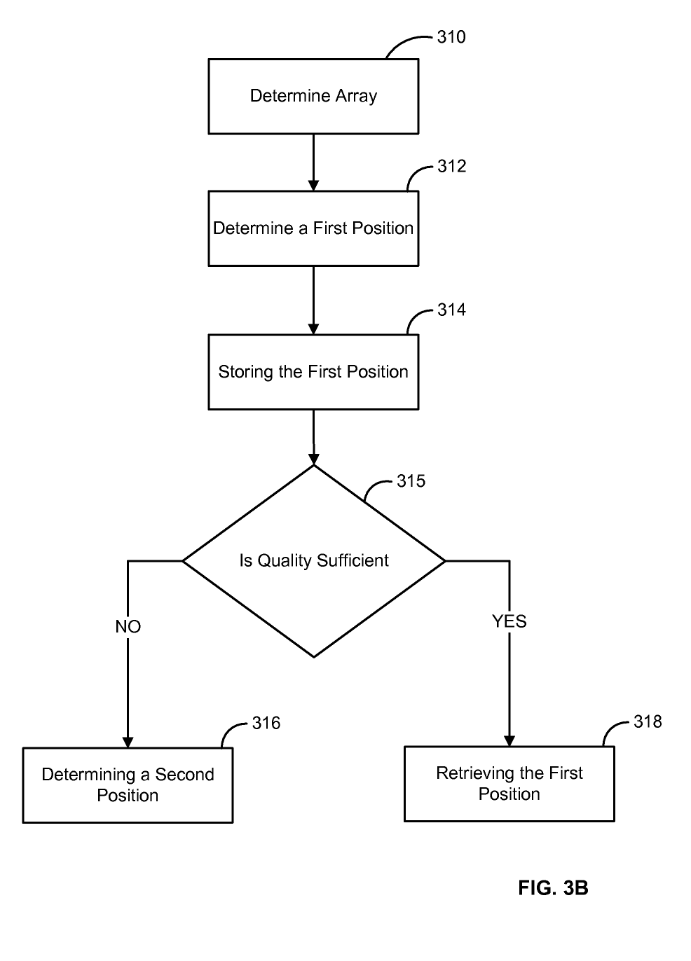

FIG. 3A illustrates an exemplary method according to the present disclosure. In an aspect, in step 300, one or more networks (e.g., an array) can be determined As an example, the determined array can comprise one or more available communication networks. As another example, a known array can comprise one or more networks known by a device and/or software application associated with a physical address, location, and/or coordinate. The device and/or application can have information relating to the array, such as information for establishing communication with the array. As a further example, the array can be determined by detecting a signal (e.g., broadcast signal) associated with one or more communication networks. In an aspect, the array can be determined by detecting one or more communication networks within a particular distance range (e.g., pre-determined range, variable range, detectable range, etc.) and/or within a particular communication band or protocol.

In step 302, a first position or location can be determined In an aspect, the first position can be determined based on information from one or more communication networks within the array and/or, but not limited to, other location based services techniques or methods (LBS methods). As an example, LBS methods can comprise Application Programming Interfaces provided for interacting with operating systems (such as iOS, Android, Blackberry etc.) in order to obtain location data such as data obtained from direct (programmatic or other) interaction with GPS, Global System for Mobile Communications (GSM) and Wi-Fi chipsets, Synthetic GPS data, Cell ID data, Inertial sensor data, barometric data, ultrasonic data, Bluetooth data, Terrestrial Transmitter data, Galileo, GLONASS, geographic IP lookup data, and/or LBS data. These and/or other techniques or methods can be used (in conjunction with each other, averaged, weighted, and the like) to determine the first position.

In step 304, the first position can be transmitted to a storage medium, database, server, and/or a central location. In an aspect, the first position can be stored for subsequent retrieval. As an example, the first position and/or other information, such as information relating to one or more networks or the array, can be transmitted and/or stored.

In step 305, one or more networks (e.g., the array) can be monitored and/or analyzed. As an example, the one or more networks can be monitored for a change in the availability of networks. Other characteristics can be monitored and/or analyzed.

In step 306, if a change is detected in one or more of the networks (e.g., the array), the second position can be determined As an example, a change in the array can comprise an addition and/or removal of one or more of the communication networks. In an aspect, the second position can be determined using information from one or more communication networks within the changed array. As an example, location based services techniques or methods, including available operating system LBS methods (iOS, Android, Blackberry etc.), direct GPS, GSM and Wi-Fi chipset data, AGPS data, Synthetic GPS data, Cell ID data, Inertial sensor data, Barometric data, Ultrasonic data, Bluetooth data and Terrestrial Transmitter data, Galileo, GLONASS or other systems generating LBS data, can be used to determine the second position. As a further example, the second position may be substantially the same position as the first position or may be a new updated position. In an aspect, the second position can be relied upon for processing by software or application(s) relying upon a present location

In step 308, if no change in one or more networks (e.g., the array) is detected, the first position can be retrieved (e.g., received, loaded, processed, extracted, referenced, or otherwise utilized). In an aspect, the first position can be relied upon for processing by software or application(s) relying upon a present location.

In an aspect, the systems and methods can read the known and unknown communication (e.g., Wi-Fi) networks into an array, store the array on a database on the device and/or post the array to an LBS server. A new LBS method can be executed for each new array. The LBS method can utilize the location framework provided by one or more operating systems or software platforms (e.g., iOS, Android, Blackberry etc.). Both the application and/or the server will have access to the location data and communication array.

In an aspect, a method can comprise determining one or more available communication networks. As an example, a first position (or an “effective” first position based on the averaging (e.g., weighted) of a set of positions obtained by utilizing one or more of the preceding partially enumerated technologies) can be determined (e.g., via GPS, AGPS, GLONASS, Galileo, geographic IP lookup, known location of one or more of the one or more available communication networks, and/or other means (e.g., in combination or apart)). As a further example, the first position can be utilized as the “current position.”

In an aspect, if a change is detected in the array (upon the expiration of a prescribed interval or otherwise, which may or may not include changes in signal strength) or if the first position is not of sufficient quality (e.g., threshold, accuracy, comparative quality), a second position (or “effective” second position based on the averaging (e.g., weighted) of a set of positions obtained from one or more of the preceding partially enumerated technologies) can be determined for use (in whole or in part) as the “current position.”

In an aspect, if no change in the one or more available networks is detected (after a prescribed interval or otherwise) and provided that the first position is of sufficient quality, the first position (or “effective” first position) can be utilized as the “current position.”

FIG. 3B illustrates an exemplary method according to the present disclosure. In an aspect, in step 310, one or more networks (e.g., an array) can be determined As an example, the determined array can comprise one or more available communication networks. As another example, a known array can comprise one or more networks known by a device and/or software application associated with a physical address, location, and/or coordinate. The device and/or application can have information relating to the array, such as information for establishing communication with the array. As a further example, the array can be determined by detecting one or more communication networks. In an aspect, the array can be determined by detecting one or more communication networks within a particular distance range (e.g., pre-determined range, variable range, detectable range, etc.) and/or within a particular communication band or protocol.

In step 312, a first position or location can be determined In an aspect, the first position can be determined based on information from one or more communication networks within the array and/or, but not limited to, other location based services techniques or methods (LBS methods). As an example, LBS methods can comprise Application Programming Interfaces provided for interacting with operating systems (such as iOS, Android, Blackberry etc.) in order to obtain location data such as data obtained from direct (programmatic or other) interaction with GPS, Global System for Mobile Communications (GSM) and Wi-Fi chipsets, Synthetic GPS data, Cell ID data, Inertial sensor data, barometric data, ultrasonic data, Bluetooth data, Terrestrial Transmitter data, Galileo, GLONASS, geographic IP lookup data, and/or LBS data. These and/or other techniques or methods can be used (in conjunction with each other, averaged, weighted, and the like) to determine the first position.

In step 314, the first position can be transmitted to a storage medium, database, server, and/or a central location. In an aspect, the first position can be stored for subsequent retrieval. As an example, the first position and/or other information, such as information relating to one or more networks or the array, can be transmitted and/or stored.

In step 315, one or more networks (e.g., the array) can be monitored and/or analyzed. As an example, the one or more networks can be monitored for a sufficiency of signal, reception, quality of location, resolution of location, accuracy, or other parameter. Other parameters can be monitored and/or analyzed. As an example, a quality of a first position can be defined by a pre-defined threshold of accuracy, by comparison to other calculated or known values or reference, and/or by other metrics used to define accuracy of location. As a further example, a sufficiency of a position (e.g., the first position) can be defined by a pre-determined threshold, by comparison to other calculated or known values or reference, and/or by other metrics used to define acceptable values of position.

The quality of the GPS location data can be determined by the number of satellites in view and the number of consecutive tight or close GPS locations over a period of time with similar satellites in view. In the case of Wi-Fi a quality location is determined by the signal strength over consecutive lookups (GPS satellites and Wi-Fi signal strength will be primary for us). Once a quality location is determined that location value can be reused for future locations to conserve battery.

In step 316, if the first position is not of sufficient quality, a second position can be determined In an aspect, the second position can be determined using information from one or more communication networks within the changed array. As an example, location based services techniques or methods including available operating system LBS methods (iOS, Android, Blackberry etc.), direct GPS, GSM and Wi-Fi chipset data, AGPS data, Synthetic GPS data, Cell ID data, Inertial sensor data, Barometric data, Ultrasonic data, Bluetooth data and Terrestrial Transmitter data, Galileo, GLONASS or other systems generating LBS data can be used to determine the second position. As a further example, the second position may be substantially the same position as the first position or may be a new updated position. In an aspect, the second position can be relied upon for processing by software or application(s) relying upon a present location

In step 318, if the first position is of sufficient quality, the first position can be retrieved (e.g., received, loaded, processed, extracted, referenced, or otherwise utilized). In an aspect, the first position can be relied on for processing by software or application(s) relying on a present location.

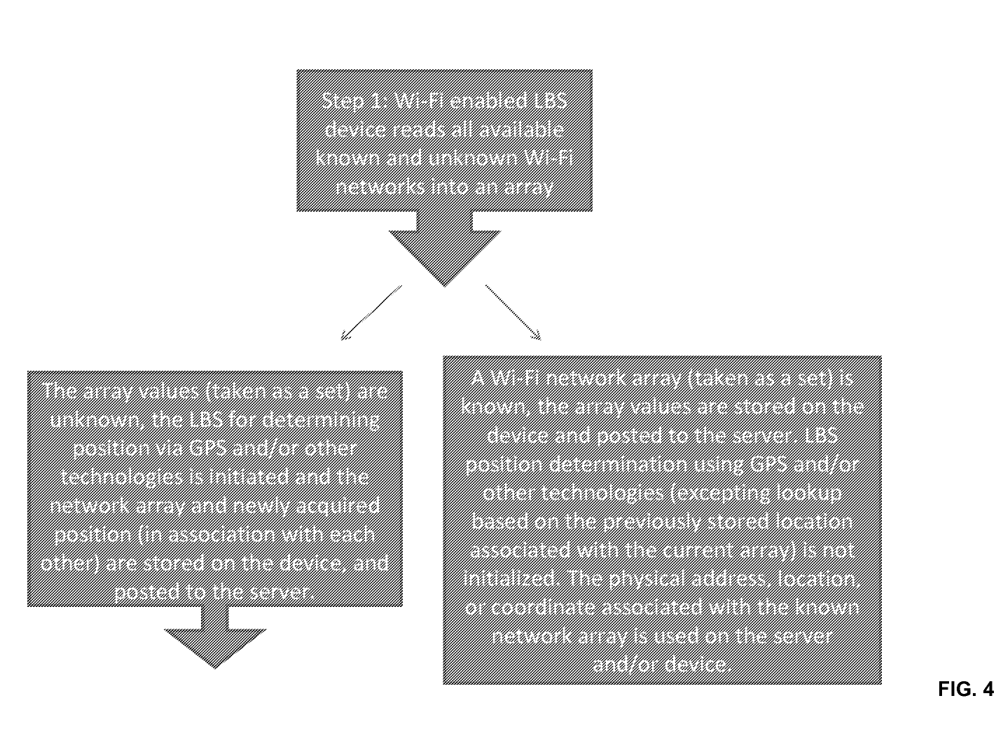

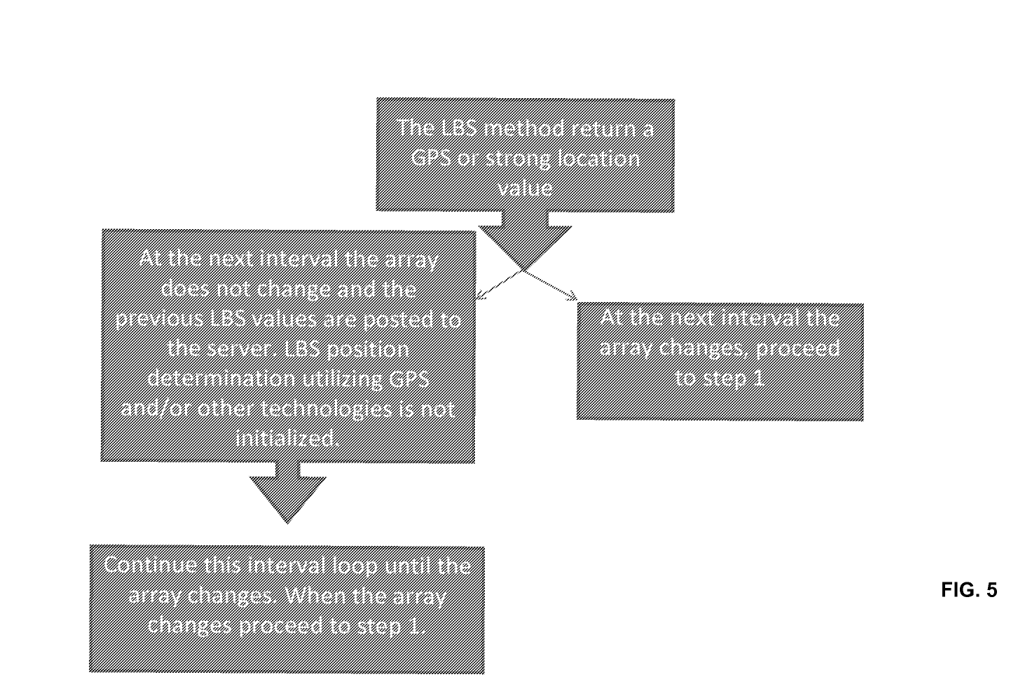

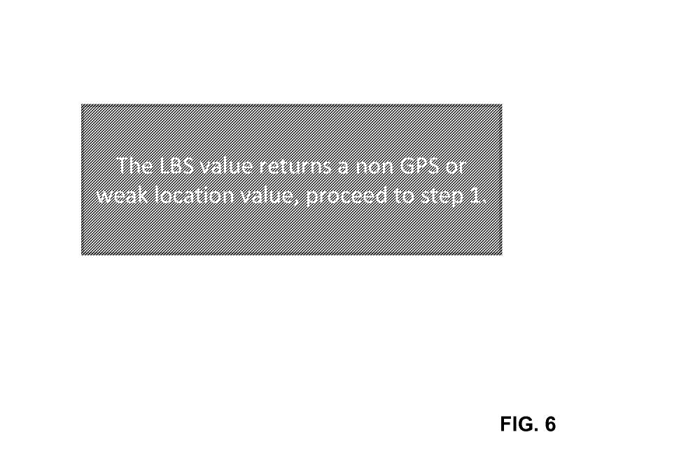

In an aspect, FIGS. 4-6 illustrate an exemplary method for an operating system, such as Android OS. As an example, if the array does not change and the LBS method reports a current GPS or strong location value, then the application can use the same LBS location data to report to the server on the next interval report and may not run a new LBS method. If the array does not change and the LBS method returns a non-GPS-based or weak location value, then the app can run a new LBS method. Non-GPS or weak location values can be returned when the GPS chipset cannot get a line of site fix or if the number of satellites to which the exemplary device has line of site visibility are below a prescribed threshold. If the array changes, the app can store the array, run a new LBS method, report the data to the server and can repeat the same process listed above. Wi-Fi networks may be turned off or may become temporarily invisible, thereby causing a value change in the array and a new LBS method to be executed. Any change in the Wi-Fi network array can cause a new LBS method to run. For added precision in cases where a device is determined to be stationary, multiple LBS methods can be run consecutively in order to obtain a set of positions which can then be averaged to yield a refined position.

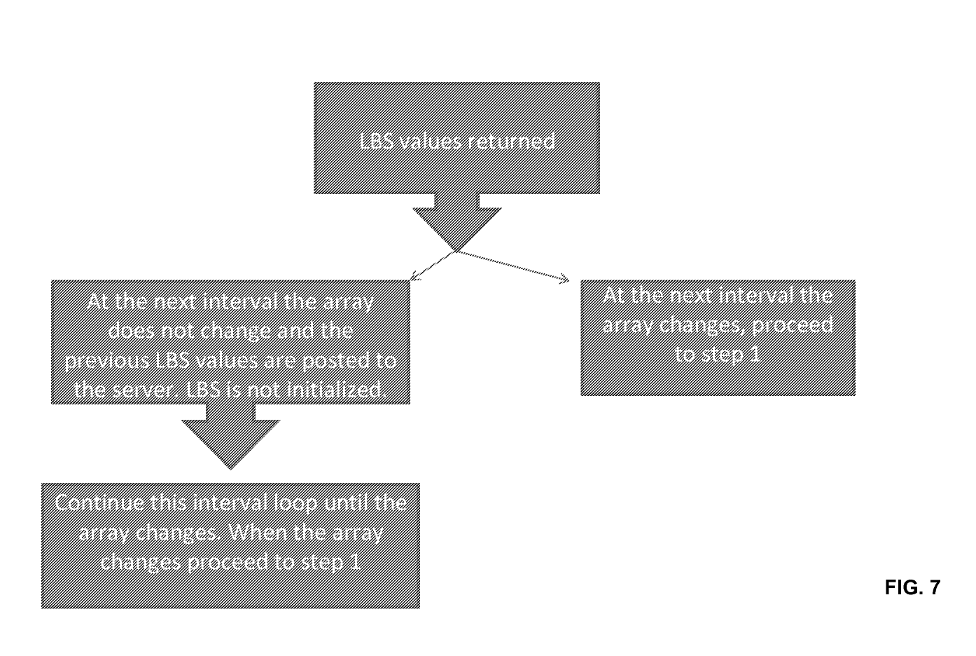

In an aspect, FIG. 7 illustrates an example method for and operating system, such as the iOS. As an example, if the array does not change then the app can use the same LBS location data to post to the server on the next interval report and may not run a new LBS method. If the array changes, the app can run a new LBS method, post the data to the server and repeat the same process listed above.

In an aspect, an array server can comprise known Wi-Fi networks. As an example, a server may already have stored the physical address of known Wi-Fi networks (or other communication networks), such as a home, office or school Wi-Fi networks. The server can pass this data to the app which will store the data in a database of “Known Wi-Fi” networks. When the app reads a current device Wi-Fi connection to a known Wi-Fi network it may not run a new LBS method but instead post to the server the known location of the Wi-Fi network upon report. The server will associate known Wi-Fi networks with the current app timestamp report. A timestamp report is typically available with all location data to provide an accurate history of the device location throughout the day.

### EXAMPLES

The following examples are put forth so as to provide those of ordinary skill in the art with a complete disclosure and description of how the systems, articles, devices and/or methods claimed herein are made and evaluated, and are intended to be purely exemplary and are not intended to limit the scope of the methods and systems.

### Example #1

### Android Unknown Wi-Fi Network

A Wi-Fi network array can comprise network ID's: [‘waypoint access2101’, ‘Amberalert5’, ‘little penguin’]

The system (e.g., software, app, or the like) and method can read the new Wi-Fi networks into an app database and perform an LBS method. The LBS method returns a non-GPS or weak location value and the system posts the data to the server. At the next reporting interval if the array has not changed, the system can run a new LBS method (because the previous location value was weak), return a GPS or other strong location value and post the data to the server. At the next interval if the array has not changed, the system may not run a new LBS method but uses the previous interval LBS data to post to the server. At the next interval if the array has changed the system can perform another (e.g., same or different) LBS method.

### Example #2

### iOS Unknown Wi-Fi Network

A Wi-Fi network array can comprise network ID's: [‘waypoint access2101’, ‘Amberalert5’, ‘little penguin’]

The system (e.g., software, app, or the like) and method can read the new Wi-Fi networks into the app database and perform a LBS method. The LBS method can return a location data value and the system posts the data to the server. At the next interval if the array has not changed, the system may not run a new LBS method but uses the previous interval LBS data to post to the server. At the next interval if the array has changed the system can perform a new LBS method (repeat above steps again).

### Example #3

### Android/iOS Known Wi-Fi Network

A Wi-Fi network array can comprise network ID's: [‘starbucks guest57’]

The system (e.g., software, app, or the like) and method previously received from the server contains the known Wi-Fi network value of ‘starbucks guest57.’ The system can read the new Wi-Fi network into the app database and will not perform a LBS method but instead post the known location associated with the Wi-Fi network ‘starbucks guest 57’ to the server.

Accordingly, the system and methods of the present disclosure can be applied to increase accuracy and optimize battery use on a device, such as a mobile device, smart phone, computing device, and the like.

One of the largest battery draining activities is running the GPS chipset. By reducing the number of times the GPS chipset is interacted with, the battery life of the device will be significantly longer in comparison to running a full LBS method at each interval. GPS location bounce will occur less often when leveraging the process described with known and unknown Wi-Fi networks and other communication networks.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
determining one or more available communication networks;
determining a first position in association with the one or more available communication networks;
if a change is detected in the one or more available communication networks, determining a second position; and
if no change in the one or more available communication networks is detected, retrieving the first position.

2. The method according to claim 1, wherein determining one or more available communication networks comprises detecting a broadcast signal associated with one or more available communication networks.

3. The method according to claim 1, wherein determining one or more available communication networks comprises detecting one or more available communication networks within a distance range.

4. The method according to claim 1, wherein the first position is determined via direct GPS, Global System for Mobile Communications (GSM) and Wi-Fi chipsets, Synthetic GPS data, Cell ID data, Inertial sensor data, barometric data, ultrasonic data, Bluetooth data, Terrestrial Transmitter data, Galileo, GLONASS, geographic IP lookup data, or a combination thereof.

5. The method according to claim 1, wherein a change in the one or more available communication networks can comprise an addition and/or removal of one or more of the communication networks.

6. The method according to claim 1, wherein the second position is determined via direct GPS, Global System for Mobile Communications (GSM) and Wi-Fi chipsets, Synthetic GPS data, Cell ID data, Inertial sensor data, barometric data, ultrasonic data, Bluetooth data, Terrestrial Transmitter data, Galileo, GLONASS, geographic IP lookup data, or a combination thereof.

7. The method according to claim 1, wherein one or more of the first position and the second position comprises an effective position.

8. A method comprising:
determining one or more available communication networks;
determining a first position in association with the one or more available communication networks;
determining a quality of the first position;
if the quality of the first position is insufficient, determining a second position; and
if the quality of the first position is sufficient, retrieving the first position.

9. The method according to claim 8, wherein determining one or more available communication networks comprises detecting a broadcast signal associated with one or more available communication networks.

10. The method according to claim 8, wherein determining one or more available communication networks comprises detecting one or more available communication networks within a distance range.

11. The method according to claim 8, wherein the first position is determined via direct GPS, Global System for Mobile Communications (GSM) and Wi-Fi chipsets, Synthetic GPS data, Cell ID data, Inertial sensor data, barometric data, ultrasonic data, Bluetooth data, Terrestrial Transmitter data, Galileo, GLONASS, geographic IP lookup data, or a combination thereof.

12. The method according to claim 8, wherein determining a quality of the first position comprises comparing the quality of the first position to a pre-determined threshold.

13. The method according to claim 8, wherein the second position is determined via direct GPS, Global System for Mobile Communications (GSM) and Wi-Fi chipsets, Synthetic GPS data, Cell ID data, Inertial sensor data, barometric data, ultrasonic data, Bluetooth data, Terrestrial Transmitter data, Galileo, GLONASS, geographic IP lookup data, or a combination thereof.

14. The method according to claim 8, wherein one or more of the first position and the second position comprises an effective position.

15. A method comprising:
determining an array comprising one or more available communication networks;
determining a first position of a user device;
associating the first position with the array;
detecting a change in the array;
determining a second position of a user device; and
associating the first position with the array.

16. The method according to claim 15, wherein determining an array comprises detecting a broadcast signal associated one or more available communication networks.

17. The method according to claim 15, wherein determining an array comprises detecting one or more available communication networks within a distance range.

18. The method according to claim 15, wherein one or more of the first position and the second position is determined via direct GPS, Global System for Mobile Communications (GSM) and Wi-Fi chipsets, Synthetic GPS data, Cell ID data, Inertial sensor data, barometric data, ultrasonic data, Bluetooth data, Terrestrial Transmitter data, Galileo, GLONASS, geographic IP lookup data, or a combination thereof.

19. The method according to claim 1, wherein a change in the array can comprise an addition and/or removal of one or more of the communication networks to the array.

20. The method according to claim 1, wherein associating one of more of the first position and the second position with the array comprises storing one or more of the first position and the second position in a database accessible by the array.
